(19) United States
(12) Patent Application Publication
(10) Pub. No.: US 2004/0036662 A1
(43) Pub. Date: Feb. 26, 2004

(54) Multidisplay control method, multidisplay control program, and recording medium containing multidisplay control program

(76) Inventor: Gou Sakumura, Kumamoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/641,087

(22) Filed: Aug. 15, 2003

(30) Foreign Application Priority Data
Aug. 22, 2002 (JP) P2002-241700

(51) Int. Cl. G09G 5/00

(52) U.S. Cl. 345/1.3

(57) ABSTRACT

A multidisplay control method, a multidisplay control program, and a recording medium containing the multidisplay control program which allows easy control over screen display on a multidisplay consisting of a plurality of displays. The multidisplay control method instructs a computer to execute: an application designating step for designating an application to be displayed on the multidisplay; a display designating step for displaying a layout of the displays on a screen, and for designating, on the screen, a combination of displays for the application designated in the application designating step to be displayed on; and an application display step for displaying the application designated in the application designating step onto the combination of displays designated in the display designating step.

### BACKGROUND OF THE INVENTION

1. Field of the Invention

The present invention relates to a multidisplay control method, a multidisplay control program, and a recording medium containing the multidisplay control program for controlling screen display in a multidisplay environment using a plurality of displays.

2. Description of the Related Art

The so-called multidisplay facility is one by which two or more displays connected with a single computer are operated to produce a screen display as if it were a single large display. A multidisplay facility is needed in such fields as DTP (DeskTop Publishing), graphics, traffic control operations, and central operations in customer centers where large volumes of information or multiple pieces of information are handled. Showing a plurality of pieces of information simultaneously allows an improved operating efficiency and faster decision making.

FIG. 1 shows how a computer screen is displayed with the multidisplay facility. In the example of FIG. 1, nine displays 51 are arranged in a 3×3 matrix, and these nine screens are controlled as a single large virtual display 50.

FIG. 2 shows an example of the control panel for use with a conventional display control program for controlling this multidisplay. The control panel of FIG. 2 has 9 control buttons 52 (the 3×3 top-left buttons) and 27 control buttons 53 (the rest). The control buttons 52 are intended to produce a screen display on the respective displays 51 in FIG. 1. The control buttons 53 correspond to combinations of displays 51, each being intended to produce a screen display across a plurality of displays 51.

For example, to show a single window on the top left-hand display 51 in FIG. 1, a “DISPLAY ON TOP LEFT” control button 52 is designated on the control panel of FIG. 2. To show a single window on the two left displays 51 in the top row in FIG. 1, a “DISPLAY ON TWO LEFT SCREENS IN TOP ROW” control button 53 is designated on the control panel of FIG. 2.

With such a control panel as shown in FIG. 2, the number of possible combinations, or patterns, of displays able to produce a screen display across a plurality of displays increases significantly with increasing numbers of displays available for multidisplay. This results in an extreme increase in the number of control buttons required.

In the example of FIG. 2, control buttons corresponding to a total of 36 patterns are needed. Specifically, the 36 patterns include 9 patterns for showing a single window on a single display, and 12 patterns, 6 patterns, 4 patterns, 4 patterns, and 1 pattern for showing a single window across two, three, four, six, and nine displays, respectively. Given that displays are arranged in a 4×4 matrix to provide 16 screens, 100 control buttons are required to deal with 100 possible display combinations.

When the number of control buttons increases thus with an increasing number of displays of the multidisplay, it becomes extremely hard to find a control button that corresponds to a desired pattern. This gives rise to the problem of extremely poor usability. Moreover, there is the problem that even if a desired button is found, designating the control button requires a large number of operations on a pointing device, keyboard, or the like.

### SUMMARY OF THE INVENTION

In view of the foregoing, it is an object of the present invention to provide a multidisplay control method, a multidisplay control program, and a recording medium containing the multidisplay control program which allow easy control over screen display in a multidisplay environment using a large number of displays.

According to a first aspect of the present invention, a multidisplay control method for controlling a screen display, on a multidisplay consisting of a plurality of displays, is provided. The method instructs a computer to execute: an application designating step for designating an application to be displayed on the multidisplay; a display designating step for displaying a layout of the displays on a screen, and designating, on the screen, a combination of displays for the application designated in the application designating step to be displayed on; and an application display step for displaying the application designated in the application designating step onto the combination of displays designated in the display designating step.

In a multidisplay environment using a large number of displays, the multidisplay control method of the present invention is performed to designate an application to be displayed on the multidisplay, and to designate a combination of displays on an on-screen layout of the individual displays constituting the multidisplay. Then, the designated application is displayed on the combination of designated displays. This allows easy control over screen display in a multidisplay environment, without usability deteriorating with an increasing number of displays.

In the display designating step, the combination of displays may be designated by a click or drag operation with a pointing device connected to the computer. Consequently, a desired state of display of the multidisplay can be designated easily by a click or drag operation with the pointing device on the on-screen layout of the individual displays constituting the multidisplay.

Here, the pointing device is a device for designating the position of input or the coordinates on-screen, such as a mouse, a trackpad, or a trackball. The click operation with the pointing device refers to an input operation such that a button or like of the pointing device is pressed and released to settle the position of input or the like. The drag operation refers to one for moving the pointing device during the input operation where the button, or the like, of the pointing device is pressed and released.

In the application display step, the designated application may be displayed over all the combination of displays designated. Consequently, when the desired state of display of the multidisplay is designated on the on-screen layout of the individual displays constituting the multidisplay, the application is displayed over all the display(s) designated. Application windows can thus be moved and adjusted in size merely by operation with the pointing device in the display designating step. This precludes the amount of operation with the pointing device from significantly increasing with an increasing number of displays, and thus allows easy control over screen display with a smaller amount of operation.

According to a second aspect of the present invention, a multidisplay control program for controlling a screen display, on a multidisplay consisting of a plurality of displays, is provided. The program makes a computer function as: an application designating means for designating an application to be displayed on the multidisplay; a display designating means for displaying a layout of the displays on a screen, and designating, on the screen, a combination of displays for the application designated by the application designating means to be displayed on; and an application display means for displaying the application designated by the application designating means onto the combination of displays designated by the display designating means.

In a multidisplay environment using a large number of displays, the multidisplay control program of the present invention is run on a computer to designate an application to be displayed on the multidisplay, and to designate a combination of displays on an on-screen layout of the individual displays constituting the multidisplay. Then, the designated application is displayed on the designated display(s). This allows easy control over screen display in a multidisplay environment, without usability deteriorating with an increasing number of displays.

The display designating means may allow designation of a combination of displays through a click or drag operation with a pointing device connected to the computer. Consequently, a desired state of display of the multidisplay can be easily designated by a click or drag operation with the pointing device on the on-screen layout of the individual displays constituting the multidisplay.

The application display means may display the designated application over all the display(s) designated. Consequently, when the desired state of display of the multidisplay is designated on the on-screen layout of the individual displays constituting the multidisplay, the application is displayed over all the display(s) designated. Application windows can thus be moved and adjusted in size merely by operation with the pointing device on the display designating means. This precludes the amount of operation of the pointing device from significantly increasing with an increasing number of displays, and thus allows easy control over screen display with a smaller amount of operation.

According to a third aspect of the present invention, a recording medium containing the foregoing multidisplay control program is provided. When the multidisplay control program recorded on this recording medium is run on a computer, the multidisplay control method described above is performed to provide the foregoing effects.

The nature, principle, and utility of the invention will become more apparent from the following detailed description when read in conjunction with the accompanying drawings in which like parts are designated by identical reference numbers.

### BRIEF DESCRIPTION OF THE DRAWINGS

In the accompanying drawings:

FIG. 1 is a diagram showing how a computer screen is displayed with a multidisplay facility;

FIG. 2 is a diagram showing an example of the control panel for use with a conventional display control program for effecting multidisplay control;

FIG. 3 is a functional block diagram schematically showing an embodiment of the present invention;

FIG. 4 is a diagram showing an example of the control panel provided by a multidisplay control program according to the embodiment of the present invention;

FIG. 5 is a flowchart showing a multidisplay control method according to the embodiment of the present invention;

FIG. 6 is a layout diagram of a group of displays constituting the multidisplay, showing an example where an application window appears on an entire single display; and

FIG. 7 is a layout diagram of a group of displays constituting the multidisplay, showing an example where an application window appears across a plurality of displays.

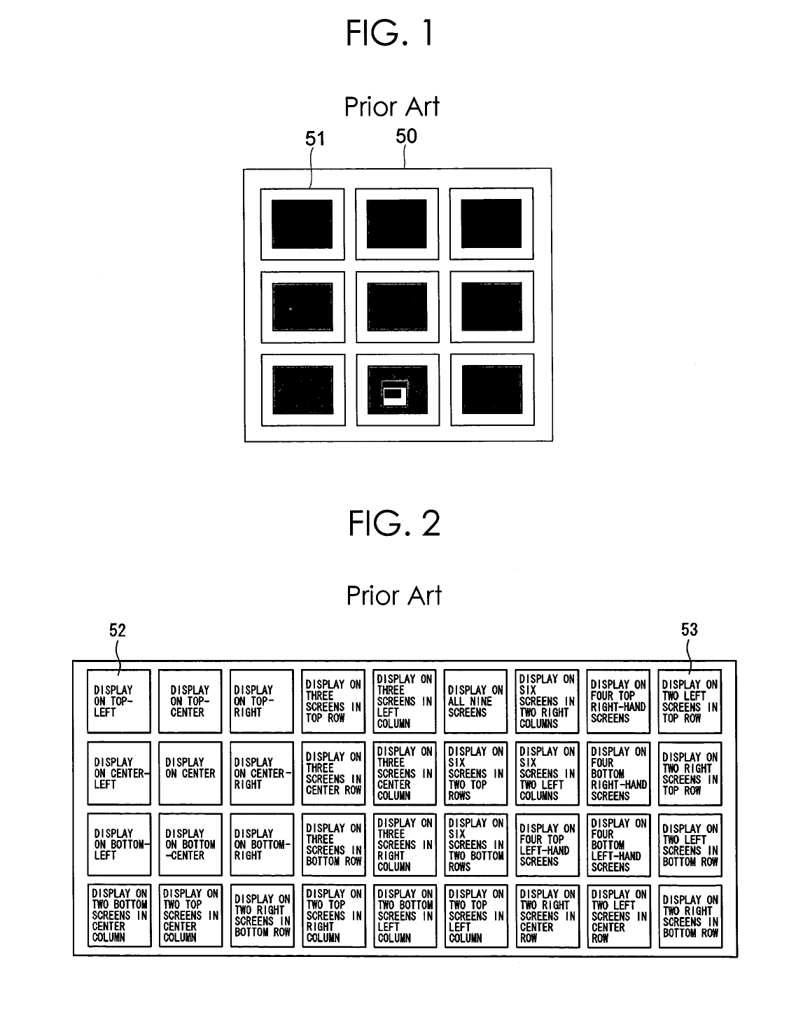

### DETAILED DESCRIPTION OF THE PREFERRED EMBODIMENT

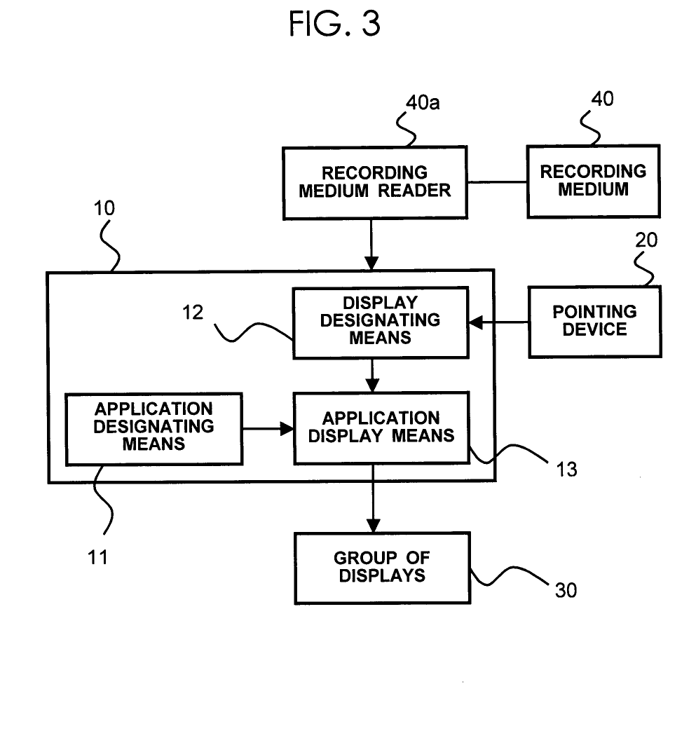

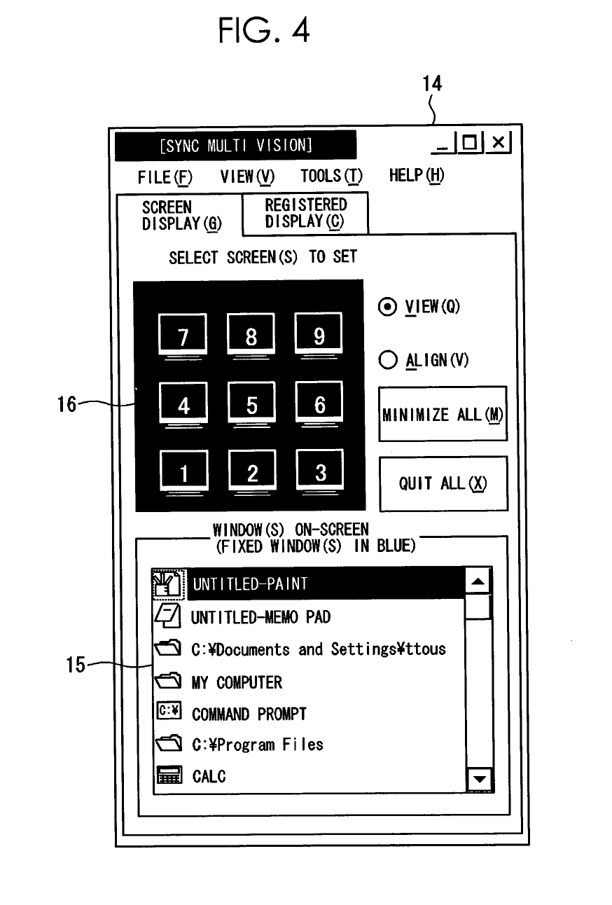

FIG. 3 is a functional block diagram schematically showing an embodiment of the present invention. FIG. 4 is a diagram showing an example of a control panel provided by a multidisplay control program according to the embodiment of the present invention.

FIG. 3 shows a computer 10, a pointing device 20, a group of displays 30, a recording medium reader 40a, and a recording medium 40 according to the present embodiment. For example, the pointing device 20 is a mouse. The group of displays 30 consists of a plurality of displays (to be described later) constituting a multidisplay. The recording medium 40 is a flexible disk (FD), for example. The recording medium 40 contains a multidisplay control program (not shown) according to the present embodiment. The recording medium reader 40a is a flexible disk drive (FD drive), for example. It can read the program recorded on the recording medium 40 under the instruction of the computer 10. The pointing device 20, the group of displays 30, and the recording medium reader 40a are connected to the computer 10.

The computer 10 reads the multidisplay control program recorded on the recording medium 40 into its RAM (not shown) by using the recording medium reader 40a. The computer 10 runs the program on its CPU (not shown) to function as an application designating means 11, a display designating means 12, and an application display means 13. The computer 10 thereby practices the multidisplay control method of the present invention.

The application designating means 11 is a means for designating an application to be shown on one or more displays designated among the group of displays 30. The application designating means 11 is implemented as an application designating frame 15 in a lower part of a control panel 14 as shown in FIG. 4.

The application designating frame 15 shows a list of applications in execution or on standby on the computer 10. The user can designate a desired application on the list displayed in the application designating frame 15 by a click operation with the pointing device 20.

The display designating means 12 is a means for displaying a layout of the individual displays constituting the group of displays 30 on a screen, and for designating, on the screen, a combination of displays for the application designated by the application designating means 11 to be displayed on. The display designating means 12 is implemented as a display selecting frame 16 in an upper part of the control panel 14 as shown in FIG. 4.

The display selecting frame 16 shows display icons corresponding to the actual layout of the individual displays constituting the group of displays 30. In the case of FIG. 4, nine display icons appear on the screen which correspond to the group of displays 30 arranged in a 3×3 (9) matrix of screens. The user designates a combination of displays by clicking or dragging the pointing device 20 over the display icons in the display selecting frame 16.

To designate a single display, one of the display icons in the display selecting frame 16 is designated by a click operation with the pointing device 20. To designate a plurality of displays, a plurality of display icons can be designated by a drag operation with the pointing device 20.

The application display means 13 is a means for displaying the application designated by the application designating means 11 onto the display(s) designated from the group of displays 30 by the display designating means 12. When a single display is designated by the display designating means 12, the application designated by the application designating means 11 appears on the single display designated. When a plurality of displays are designated, the designated application appears across the plurality of displays designated.

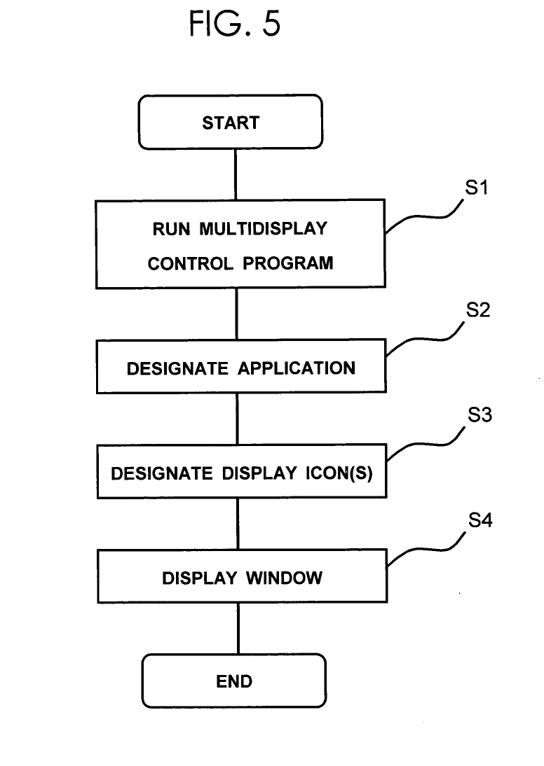

FIG. 5 is a flowchart of the multidisplay control method according to the present embodiment. Hereinafter, referring to FIG. 5, description will be given of an example of screen display control by the computer that executes the multidisplay control program of the foregoing configuration.

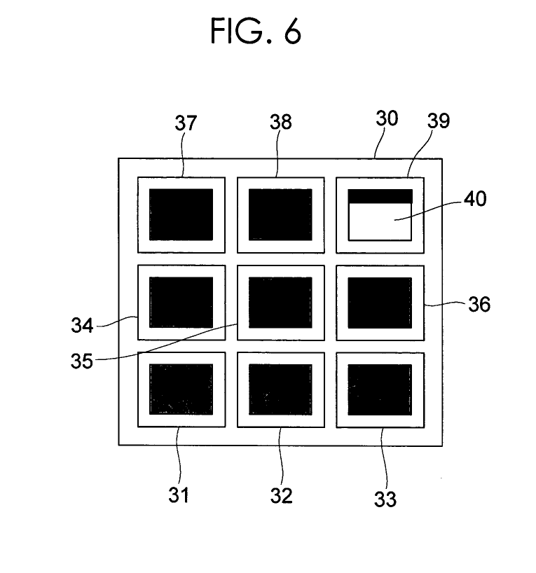

FIG. 6 is a layout diagram of the group of displays 30 constituting the multidisplay.

As shown in FIG. 6, the group of displays 30 according to the present embodiment consists of: displays 31, 32, and 33 arranged from the left to the right in the bottom row; displays 34, 35, and 36 arranged similarly in the second row from the bottom; and displays 37, 38, and 39 in the third row from the bottom. The display icons “1” to “9” in the display selecting frame 16 shown in FIG. 4 correspond to the displays 31 to 39 shown in FIG. 6, respectively.

Under the user's instructions, the computer 10 reads the multidisplay control program from the recording medium 40 and runs the same (step S1 in FIG. 5). Then, the control panel 14 shown in FIG. 4 appears. The user operates the pointing device 20 to designate a desired application from the list of applications displayed in the application designating frame 15 (step S2). The user also designates a display icon or display icons, corresponding to the display(s) for the selected application to be displayed on, out of the display icons in the display designating frame 16 (step S3).

For example, when the user designates the single top right-hand display icon “9” out of the display icons in the display selecting frame 16, the application display means 13 displays a window 40 of the application designated from the application designating frame 15 as shown in FIG. 6, i.e., on the entire single display 39 in the group of displays 30 that corresponds to the display icon “9” (step S4).

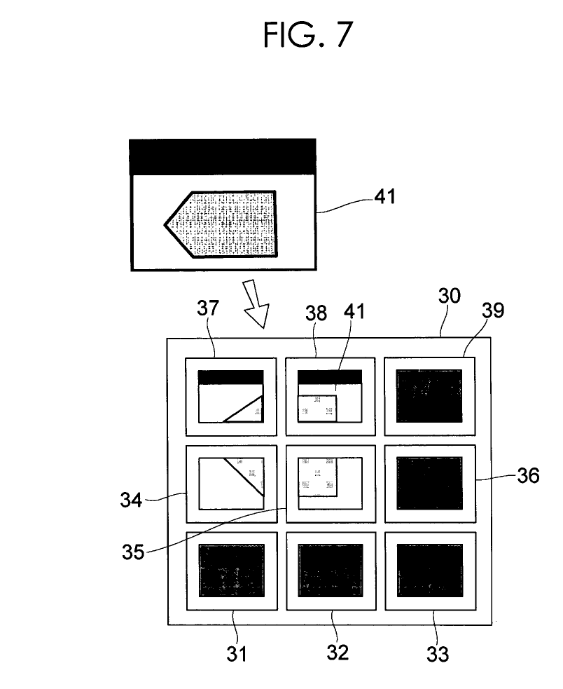

When the user designates the four top left-hand display icons “4,” “5,” “7,” and “8” out of the display icons in the display selecting frame 16, the application display means 13 displays a window 41 of the application designated from the application designating frame 15 as shown in FIG. 7, i.e., across the four displays 34, 35, 37, and 38 in the group of displays 30 that correspond to the display icons “4,” “5,” “7,” and “8” (step S4).

As above, with the computer that runs the multidisplay control program of the present embodiment, a designated application can be displayed on a designated display or displays by simply designating the application to be displayed on the group of displays 30 by means of the application selecting frame 15 on the control panel 14, and by designating a combination of displays for the application to be displayed on by means of the display selecting frame 16.

Moreover, the application and display designations, from this control panel 14, can be easily made by a click or drag operation with the pointing device 20. Furthermore, since the designated application is displayed over all the designated display(s), application windows can be moved and adjusted in size merely by operating the pointing device 20 on the control panel 14.

The foregoing embodiment has dealt with the case where the pointing device 20 is a mouse. However, the present invention is not limited thereto. For example, the pointing device 20 may be a trackball, a pen tablet, or other pointing devices.

The foregoing embodiment has dealt with the case where the group of displays 30 consists of nine displays 31 to 39. However, the present invention is not limited thereto. The group of displays 30 may include any number of displays. The layout of the displays constituting the group of displays 30 is not limited to the foregoing embodiment, either.

The foregoing embodiment has dealt with the case where the recording medium 40 is a flexible disk. However, the present invention is not limited thereto. For example, the recording medium 40 may be a hard disk, a CD-ROM, a DVD-ROM, or other recording medium.

While there has been described what is at present considered to be a preferred embodiment of the invention, it will be understood that various modifications may be made thereto, and it is intended that the appended claims cover all such modifications as fall within the true spirit and scope of the invention.

What is claimed is:

1. A multidisplay control method for controlling screen display on a multidisplay consisting of a plurality of displays,
the method instructing a computer to execute:
an application designating step for designating an application to be displayed on the multidisplay;
a display designating step for displaying a layout of the displays on a screen, and for designating, on the screen, a combination of displays for said application designated in the application designating step to be displayed on; and
an application display step for displaying said application designated in the application designating step onto said combination of displays designated in the display designating step.

2. The multidisplay control method according to claim 1, wherein in the display designating step, the combination of displays is designated by any one of a click operation and a drag operation with a pointing device connected to said computer.

3. The multidisplay control method according to claim 1, wherein in the application display step, said designated application is displayed over all said combination of designated displays.

4. The multidisplay control method according to claim 2, wherein in the application display step, said designated application is displayed over all said combination of designated displays.

5. A multidisplay control program for controlling screen display on a multidisplay consisting of a plurality of displays,
the program making a computer function as:
an application designating means for designating an application to be displayed on the multidisplay;
a display designating means for displaying a layout of the displays on a screen, and for designating, on the screen, a combination of displays for said application designated by the application designating means to be displayed on; and
an application display means for displaying said application designated by the application designating means onto said combination of displays designated by the display designating means.

6. The multidisplay control program according to claim 5, wherein said display designating means allows designation of the combination of displays through any one of a click operation and a drag operation with a pointing device connected to said computer.

7. The multidisplay control program according to claim 5, wherein the application display means displays said designated application over all said combination of displays designated.

8. The multidisplay control program according to claim 6, wherein the application display means displays said designated application over all said combination of displays designated.

9. A computer-readable recording medium containing the multidisplay control program, according to claim 5, for running on a computer.

10. A computer-readable recording medium containing the multidisplay control program, according to claim 6, for running on a computer.

11. A computer-readable recording medium containing the multidisplay control program, according to claim 7, for running on a computer.

12. A computer-readable recording medium containing the multidisplay control program, according to claim 8, for running on a computer.
